(19) United States
(12) Patent Application Publication
(10) Pub. No.: US 2013/0266280 A1
(43) Pub. Date: Oct. 10, 2013

(54) PHOTOELECTRIC COMPOSITE CABLE

(71) Applicant: SUMITOMO ELECTRIC INDUSTRIES, LTD., Osaka (JP)

(72) Inventors: Itaru SAKABE, Yokohama-shi (JP); Yuya HOMMA, Yokohama-shi (JP); Tomoki SEKIGUCHI, Yokohama-shi (JP); Hajime ARAO, Yokohama-shi (JP); Tatsunori HAYASHISHITA, Hachinohe (JP)

(73) Assignee: SUMITOMO ELECTRIC INDUSTRIES, LTD., Osaka (JP)

(21) Appl. No.: 13/857,192

(22) Filed: Apr. 5, 2013

(30) Foreign Application Priority Data
Apr. 6, 2012 (JP) 2012-087273

(51) Int. Cl. H01B 11/22; H01R 3/00; G02B 6/44

(52) U.S. Cl. CPC H01B 11/22; G02B 6/4416; H01R 3/00
USPC 385/101; 174/70 R; 174/84 R

(57) ABSTRACT

The photoelectric composite cable 11 includes: an optical fiber 12; and a plurality of three or more electric wires 15, wherein, in a case where a cross-section of the photoelectric composite cable is viewed in a direction perpendicular to the cross-section, the plurality of electric wires 15 are each independently arranged on a circumference of a periphery of the optical fiber 12. The photoelectric composite cable 11 can be smoothly wired in a narrow space or the like while maintaining good transmission characteristics of optical fibers 12 by suppressing the optical fibers 12 from being applied with an external force without an increase in the diameter of the cable 11.

This application claims priority from Japanese Patent Application No. 2012-087273, filed on Apr. 6, 2012, the entire contents of which are hereby incorporated by reference.

### FIELD OF THE INVENTION

The present invention relates to a photoelectric composite cable having electric wires and optical fibers.

### DESCRIPTION OF RELATED ART

Medical devices, video cameras, and personal computers and peripheral devices thereof have been further advanced in their functions. Thus high-speed communication is required on them.

As a photoelectric composite cables, a photoelectric composite cable in which a plurality of optical fibers are arranged on the outer periphery of a core material at intervals, a sectioning sheet which coats the core material and the optical fibers is provided on the outside thereof, quad-stranded electric wires are arranged at positions corresponding to the intervals of the optical fibers on the outside of the sectioning sheet, and a jacket is provided on the outside thereof is known (for example, refer to JP-UM-A-60-109216).

However, when the electric wires arranged on the outer periphery of the optical fibers are twisted wires or quad-stranded wires, the diameter of the cable is increased, and it is difficult to smoothly perform wiring of the cable in a narrow space or the like, In addition, when the electric wires such as the stranded wires are eccentrically arranged toward the peripheral direction, bending stiffness of the cable becomes large. Therefore, it is difficult to bend the cable, and there is a concern of the cable meandering, In this case, the transmission loss of a signal that propagates in the optical fibers is increased.

### SUMMARY OF INVENTION

An object of the invention is to provide a photoelectric composite cable capable of being smoothly wired in a narrow space or the like while maintaining good transmission characteristics of optical fibers by suppressing the optical fibers from being applied with an external force without an increase in the diameter of the cable.

In order to accomplish the object, a photoelectric composite cable according to the invention includes: an optical fiber; and a plurality of three or more power supply wires, in which, in a case where a cross-section of the photoelectric composite cable is viewed in a direction perpendicular to the cross-section, the plurality of power supply wires are each independently arranged on a circumference of a periphery of the optical fiber.

In addition, it is preferable that the photoelectric composite cable according to the invention further include a protective tube which accommodates the optical fiber therein, and in the case where the cross-section of the photoelectric composite cable is viewed in the direction perpendicular to the cross-section, the plurality of power supply wires be arranged to be unidirectionally stranded or stranded in two different directions on an outer periphery of the protective tube.

In addition, in the photoelectric composite cable according to the invention, it is preferable that, in the case where the cross-section of the photoelectric composite cable is viewed in the direction perpendicular to the cross-section, the plurality of power supply wires be arranged at equal intervals on the outer periphery of the protective tube,

In addition, it is preferable that the photoelectric composite cable according to the invention further include connectors having a positive electrode and a negative electrode, and the plurality of power supply wires be connected to at least one of the positive electrode and the negative electrode.

In addition, in the photoelectric composite cable according to the invention, it is preferable that, among the plurality of power supply wires, the power supply wires connected to the positive electrode are arranged to be adjacent to one another, and the power supply wires connected to the negative electrode are arranged to be adjacent to one another.

In addition, in the photoelectric composite cable according to the invention, it is preferable that the connectors have any one of a light-receiving element which converts an optical signal into an electrical signal and a light-emitting element which converts an electrical signal into an optical signal. In addition, in a cable used for unidirectional communication, connectors are provided at both terminals of the cable, the one connector is provided with a light-receiving element which converts an optical signal into an electrical signal, and the other connector is provided with a light-emitting element which converts an electrical signal into an optical signal. In a cable used for bidirectional communication, connectors at both terminals thereof are provided with a light-receiving element which converts an optical signal into an electrical signal and a light-emitting element which converts an electrical signal into an optical signal.

According to the photoelectric composite cable of the present invention, the power supply wires consist of at least 3 wires, and the diameter of each of the power supply wires is reduced. Since the power supply wires are each independently arranged on the circumference of the periphery of the optical fiber, the outside diameter of the cable may be reduced compared to a case where power supply wires are accommodated in the periphery of the optical fiber in a state of twisted wires or quad-stranded wires. Accordingly, the cable may be smoothly wired in a narrow space or the like while maintaining good transmission characteristics of the optical fiber by suppressing the optical fiber from being applied with an external force without an increase in the diameter of the cable.

### BRIEF DESCRIPTION OF THE DRAWINGS

FIG. 1 is a conceptual diagram illustrating a usage example of a photoelectric composite cable according to the invention;

FIG. 2 is a cross-sectional view of the photoelectric composite cable according to the invention;

FIG. 3 is a cross-sectional view of a photoelectric composite cable according an example;

FIG. 4 is a cross-sectional view of a modification example of the example; and

FIG. 5 is a cross-sectional view of a photoelectric composite cable according a comparative example.

### DETAILED DESCRIPTION OF EXEMPLARY EMBODIMENT

Hereinafter, an example of an embodiment of a photoelectric composite cable according to the invention will be described with reference to the drawings.

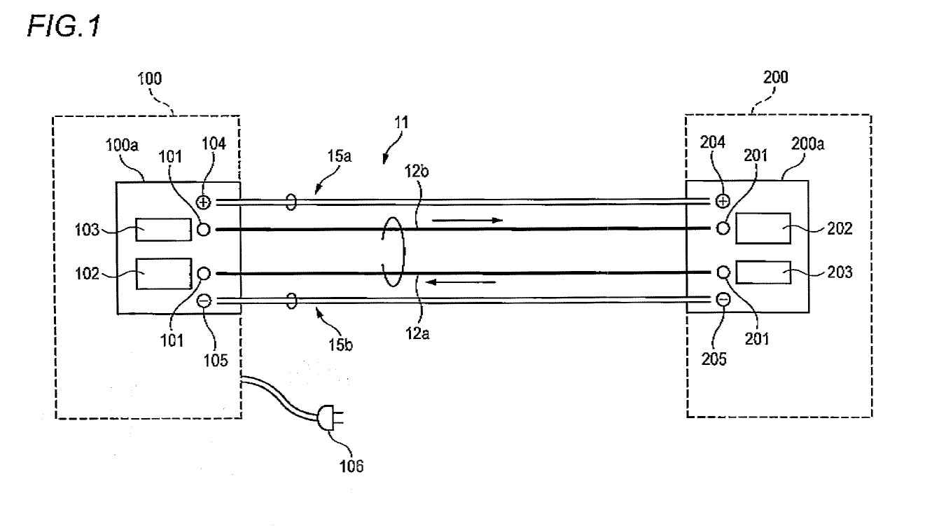

FIG. 1 is a conceptual diagram illustrating, as an example of using a photoelectric composite cable 11, a state where a personal computer 100 and a power feed type hard disk 200 are electrically and optically connected by the photoelectric composite cable 11. As illustrated in FIG. 1, the photoelectric composite cable 11 connects a personal computer side connector 100a (an example of connector) connected to a cable connection portion of the personal computer 100 to a hard disk side connector 200a (an example of connector) connected to a cable connection portion of the power feed type hard disk 200.

The personal computer side connector 100a includes: a light-receiving element 102 which receives an optical signal transmitted from the power feed type hard disk 200 through an optical fiber core 12a via a lens 101; a light-emitting element 103 which transmits an optical signal of the personal computer 100 side to an optical fiber core 12b via a lens 101; a positive electrode 104 connected to five electric wires 15a; and a negative electrode 105 connected to five electric wires 15b. In addition, the personal computer 100 has an electrical outlet 106.

The hard disk side connector 200a includes: a light-receiving element 202 which receives the optical signal transmitted through the optical fiber core 12b via a lens 201; a light-emitting element 203 which transmits the optical signal to the optical fiber core 12a via a lens 201; a positive electrode 204 connected to the electric wires 15a; and a negative electrode 205 connected to the electric wires 15b.

The power feed type hard disk 200 is operated by being supplied with power from the personal computer 100 through the electric wires 15 (hereinafter, there may be cases where the electric wires 15a and 15b are collectively called the electric wires 15) accommodated in the photoelectric composite cable 11. That is, the electric wires 15 are power supply wires. In addition, the power feed type hard disk 200 performs high-speed communication through the optical fiber cores 12 (hereinafter, there may be cases where the optical fiber cores 12a and 12b are collectively called the optical fiber cores 12) to exchange data with the personal computer 100.

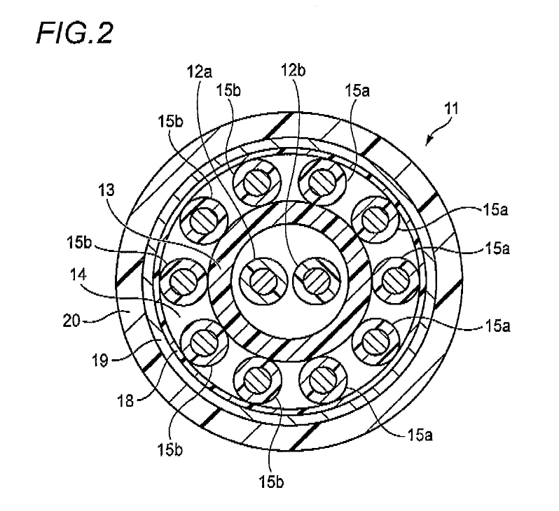

Next, the internal configuration of the photoelectric composite cable 11 will be described with reference to FIG. 2.

As illustrated in FIG. 2, the photoelectric composite cable 11 has two optical fiber cores 12 and ten electric wires 15 on the inside of a jacket 20 which is the outermost layer. The optical fiber cores 12 has one optical fiber core 12a for transmitting a signal from the power feed type hard disk 200 to the personal computer 100, and one optical fiber core 12b for transmitting a signal from the personal computer 100 to the power feed type hard disk 200. The two optical fiber cores 12 are disposed at the cross-sectional center of the photoelectric composite cable 11 in a state of being accommodated in a protective tube 13.

The optical fiber cores 12 accommodated in the protective tube 13 are made by forming a coating layer made of a UV-curable resin on the periphery of a glass fiber including a core and a cladding, where the core diameter is 0.08 mm, the outside diameter of the glass fiber is 0.125 mm, and the outside diameter of the coating layer is 0.25 mm. In addition, a coating layer may further be provided to form an optical fiber core 12 having an outside diameter of 0.9 mm, or an optical fiber cord having a tensile strength fiber and a coating layer that cover the optical fiber core 12 may also be formed,

The optical fiber core 12 may be a hard plastic clad fiber (H-PCF) which has a core formed of a glass and a cladding formed of a high-hardness plastic and is thus robust to bending (kink) and difficult to be broken, or may be a plastic fiber having a core and a cladding made of a plastic. The optical fiber core 12 may be a multi-mode fiber or a single-mode fiber. As the multi-mode fiber, a graded-index core (GI core) type is particularly preferable. In the case of the glass fiber, it is more preferable to have a W-shaped structure (trench structure) in which the refractive index is reduced in the periphery of a GI core.

In a case where the photoelectric composite cable 11 has a very small diameter and is used without being bent like, for example, a CCD cord which is a medical sensor cord, a glass cladding fiber may be used as the optical fiber core 12. In a case where the photoelectric composite cable 11 has a small diameter and is bent like a USB (Universal Serial Bus) cable or an HDMI (High-Definition Multimedia Interface) cable, it is preferable to use a hard plastic clad fiber.

The two optical fiber cores 12 are accommodated inside the protective tube 13. Only the optical fiber cores 12 may be accommodated inside the protective tube 13, but a tensile strength fiber or an filler may also be accommodated along with the optical fiber cores 12 to increase strength. There may be cases where three or more optical fiber cores 12 are accommodated in the protective tube 13, or there may be cases where a single optical fiber core 12 is accommodated. In this embodiment, in a case where a plurality of optical fiber cores 12 are accommodated in the protective tube 13, a configuration in which the optical fiber cores 12 are vertically added without being stranded is exemplified. However, the optical fiber cores 12 may be unidirectionally stranded or in two different directions stranded such as SZ-stranded to be accommodated in the protective tube 13.

It is preferable that the protective tube 13 has a function as a buffer material that appropriately absorbs a side pressure from the electric wires 15 and the like while protecting the optical fiber cores 12 from an external force. Therefore, the protective tube 13 is formed of, for example, a resin having an elastic modulus of 50 to 1000 MPa and has a thickness of 0.2 mm or greater. In this configuration, the side pressure applied to the optical fiber cores 12 may be suppressed to be low by the protection by the protective tube 13.

As the material of the protective tube 13, polyvinyl chloride (PVC) or a tetrafluoroethylene-ethylene copolymer (ETFE) resin is preferably used, and a polybutylene terephthalate (PBT) resin may be used. The protective tube 13 is formed by extrusion-coating a resin onto the periphery of the arranged optical fiber cores 12 to cover the optical fiber cores 12.

An accommodation portion 14 is formed inside the jacket 20 and outside the protective tube 13, and the ten electric wires 15 are arranged in the accommodation portion 14. As illustrated in FIG. 2, when the cross-section of the photoelectric composite cable 11 is viewed in a direction perpendicular to the cross-section, the ten electric wires 15 are arranged on the circumference of the periphery of the optical fiber cores 12 at equal intervals, In addition, the ten electric wires 15 are each independently arranged in a layer-stranded state on the outer periphery of the protective tube 13.

In addition, as illustrated in FIG. 2, when the cross-section of the photoelectric composite cable 11 is viewed in the direction perpendicular to the cross-section, among the ten electric wires 15, the five electric wires 15a are arranged to be adjacent to one another at equal intervals. In addition, among the ten electric wires 15, the five electric wires 15b are arranged to be adjacent to one another at equal intervals. As such, by arranging the electric wires 15 at equal intervals, there is no difference in the bending stiffness of the photoelectric composite cable 11 even when the photoelectric composite cable 11 is bent to any direction. That is, the photoelectric composite cable 11 does not have a configuration in which the bending stiffness of local part of the outer periphery of the photoelectric composite cable 11 becomes large, and thus the protective tube 13 that accommodates the optical fiber cores 12 does not meander. Therefore, the optical fiber cores 12 do not meander and transmission loss due to an influence of bending is suppressed.

As illustrated in FIG. 1, each of one ends of the five electric wires 15a are connected to the positive electrode 104 mounted in the personal computer side connector 100a, and each of the other ends of the five electric wires 15a is connected to the positive electrode 204 mounted in the hard disk side connector 200a. In addition, each of one ends of the five electric wires 15b is connected to the negative electrode 105 mounted in the personal computer side connector 100a, and each of the other ends of the five electric wires 15b is connected to the negative electrode 205 mounted in the hard disk side connector 200a.

As any of the electric wires 15a and 15b, an insulating cable in which a conductor made by stranding a plurality of element wires made of a tin-plated annealed copper wire or a copper alloy wire is covered with a jacket may be used, and a cable of about AWG 20 to 46 according to the American Wire Gauge (AWG) standard is preferably used, As the material of the jacket of the insulating cable, a fluororesin such as a tetrafluoroethylene-perfluoroalkyl vinyl ether copolymer (PFA) resin having excellent heat resistance, chemical resistance, non-adhesiveness, and self-lubricating properties is preferably used. In addition, as the jacket of the insulating cable, a polyethylene (PE) resin or a polyvinyl chloride (PVC) resin may be used.

In addition, in the periphery of the accommodation portion 14, a press-winding portion 18, a shielding layer 19, and the jacket 20 are provided in this order.

As the press-winding portion 18, for example, a resin tape formed of a polyethylene terephthalate (PET) resin having excellent heat resistance, abrasion resistance, and the like is used, In addition, as the press-winding portion 18, a paper tape or a resin tape made of a polytetrafluoroethylene (PTFE) resin may be used.

The shielding layer 19 is made by braiding, for example, tin-plated cooper wires or copper alloy wires having an outside diameter of tens of micrometers (for example, an outside diameter of about 0.03 mm or 0.04 mm) and is formed to have a thickness of about 0.1 mm. In addition, as the shielding layer 19, copper wires or copper alloy wires may be spirally wound, or a metal resin tape having a copper foil or an aluminum foil adhered to a resin tape formed of a polyethylene terephthalate (PET) resin may be wound.

The jacket 20 is formed of, for example, polyvinyl chloride (PVC) or a polyolefin-based resin. As a non-halogenated polyolefin-based resin, there are mixtures of elastomers such as an ethylene-vinyl acetate copolymer (EVA), polyethylene (PE), and a styrene ethylene butylene styrene block copolymer (SEBS). In addition, those made by adding a weather-resistant agent, an antioxidant, and an anti-aging agent to polyethylene (PE) may be used. In addition, as the jacket 20 that uses polyethylene (PE), a non-flame-retardant material without a flame retardant included may be used.

According to the photoelectric composite cable 11 configured as described above, the five electric wires 15a for the positive electrodes and the five electric wires 15b for the negative electrodes are arranged on the circumference of the periphery of the optical fiber cores 12 at equal intervals. In addition, the ten electric wires 15 are each independently arranged in a layer-stranded state on the outer periphery of the protective tube 13.

The cross-sectional area of the conductor of the electric wires 15 accommodated in the photoelectric composite cable 11 is determined according to the electric energy supplied to the photoelectric composite cable 11. For example, when a cross-sectional area corresponding to a required electric energy is to be ensured by a single electric wire for the positive electrodes and a single electric wire for the negative electrodes, the cross-sectional area of the single electric wire is increased, and the outside diameter of the single electric wire is increased. When the outside diameter of the single electric wire is increased, the outside diameter of the photoelectric composite cable is also increased. Here, in the photoelectric composite cable 11 of this embodiment, a cross-sectional area corresponding to a required electric energy is ensured by the ten electric wires 15. That is, as described above, the number of electric wires 15a connected to the positive electrodes is five, and the number of electric wires 15b connected to the negative electrodes is five.

Since the number of electric wires 15a for the positive electrodes is five (a single cross-sectional area is divided into five cross-sectional areas for reduction in diameter), the cross-sectional area per single electric wire is reduced, and thus the outside diameter of the electric wire 15a is reduced. Similarly, since the number of electric wires 15b for the negative electrodes is five (a single cross-sectional area is divided into five cross-sectional areas for reduction in diameter), the cross-sectional area per single electric wire is reduced, and thus the outside diameter of the electric wire 15b is reduced. Therefore, the outside diameter of the photoelectric composite cable 11 is reduced.

In addition, in this embodiment, an example in which the electric wire for the positive electrodes is divided into the five electric wires for reduction in diameter and the electric wire for the negative electrodes is divided into the five electric wires for reduction in diameter is described, but the embodiment is not limited to this example. The electric wire is divided into a plurality of electric wires for reduction in diameter by determining the number of electric wires depending on a required electrical energy and the length of the outer periphery of the protective tube 13. When the divided electric wires are arranged on the circumference of the periphery of the optical fiber cores 12, the outside diameter of the photoelectric composite cable 11 may be reduced, compared to a case where a single electric wire for the positive electrodes and a single electrode for the negative electrodes are configured.

In addition, according to the configuration of the photoelectric composite cable 11 of this embodiment, compared to a case where twisted wires such as an STP (shielded twist pair cable) or a UTP (unshielded twist pair cable) or quad-stranded wires are accommodated on the circumference of the periphery of the optical fiber cores 12, the thicknesses of accommodation parts are reduced, thereby achieving reduction in diameter. Accordingly, the optical fiber cores 12 are suppressed from being applied with an external force without an increase in the diameter of the cable, the optical fiber cores 12 may be smoothly wired in a narrow space or the like while maintaining good transmission characteristics. In addition, since the five electric wires 15a are connected to the positive electrode 104, even when one from among the five electric wires is broken, power feeding may be performed by the remaining four electric wires,

In addition, since the photoelectric composite cable 11 has the structure in which the ten electric wires 15 are accommodated at equal intervals to be arranged with a good balance, without causing an increase in diameter by providing unnecessary filler in the accommodation portion 14, uneven portions on the outer peripheral surface of the cable are excessively suppressed. Therefore, application of a local side pressure onto the optical fiber cores 12 when the cable is bent may be prevented.

In addition, since the electric wires 15a are arranged to be adjacent and the electric wires 15b are arranged to be adjacent to achieve a good balance in the photoelectric composite cable 11, when the electric wires 15a and 15b are bundled at one point in the peripheral direction in the terminal part of the photoelectric composite cable 11, the electric wires 15a and 15b are extremely suppressed from being twisted, thereby enhancing workability. In addition, by arranging the electric wires 15a and 15b with a good balance, even when the photoelectric composite cable 11 is manufactured by extruding the jacket 20, a core assembly including the protective tube 13 that accommodates the optical fiber cores 12 and the electric wires 15 may be suppressed from being twisted to the minimum, thereby enhancing productivity.

In addition, in the photoelectric composite cable 11 of this embodiment described above, an example in which the plurality of electric wires 15 are arranged on the outer periphery of the protective tube 13 at equal intervals is described. However, when the plurality of electric wires 15 are arranged at equal intervals, filler may be mounted in a gap between the electric wires. In addition, the adjacent electric wires may be caused to come into contact with each other, that is, to abut each other.

In addition, in this embodiment, the ten electric wires 15 are used as power supply wires for power supply. However, other electric wires (for example, a group of two electric wires) may be included in the accommodation portion 14 to be used as a signal line for differential transmission or a signal line for other purposes.

Next, an example of the photoelectric composite cable 11 will be described.

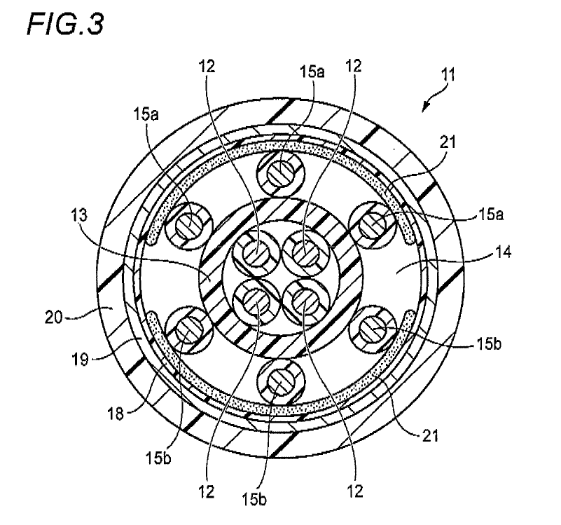

In the example, as illustrated in FIG. 3, four optical fiber cores 12 having an outside diameter of 0.25 mm was accommodated in a protective tube 13 having an inside diameter of 1.0 mm and an outside diameter of 2.0 mm. Six electric wires 15 (three electric wires 15a for positive electrodes and three electric wires 15b for negative electrodes) of AWG 28 according to the AWG (American Wire Gauge) standard were each independently arranged on the outer periphery of the protective tube 13 in a layer-stranded state around the protective tube 13. The outside diameter of the electric wire 15 was 0.5 mm. The pitch of the layer strands of each of the electric wires 15 was 60 mm. Kevlar 21 which is an example of a tensile strength member was disposed outside the electric wires 15, In addition, each of the electric wires 15 was used as a power supply wire.

As a result of the configuration as described above, the optical fiber cores 12, the protective tube 13, the electric wires 15, and the Kevlar 21 described above were able to be accommodated in a jacket 20 (PVC tube) having an inside diameter of 3.2 mm and an outside diameter of 4.2 mm.

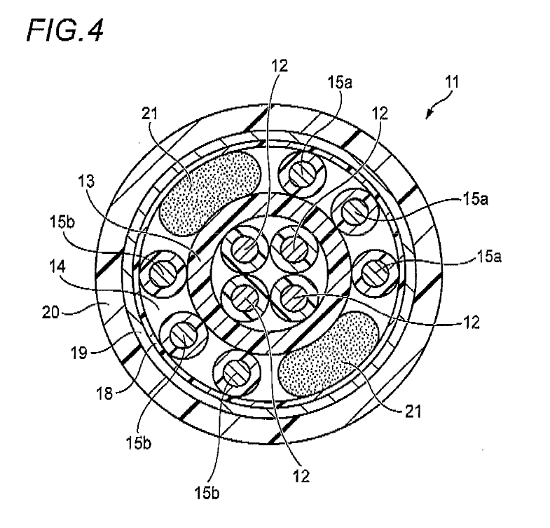

In addition, in this example, as illustrated in FIG. 3, the Kevlar 21 was disposed outside the electric wires 15, but this example is not limited thereto. As illustrated in FIG. 4, the Kevlar 21 may be arranged between the electric wire 15a for the positive electrodes and the electric wire 15b for the negative electrodes when the photoelectric composite cable 11 is viewed in the cross-section perpendicular to the lengthwise direction, and at positions having point symmetry with respect to the center of the photoelectric composite cable 11. In FIG. 4, two pieces of the Kevlar 21 are arranged to have uniform intervals. In this configuration, a stretching force of the photoelectric composite cable 11 when being bent may be scattered along the periphery. In addition, a tensile strength member such as the Kevlar 21 may be accommodated in the protective tube 13 together with the optical fiber cores 12.

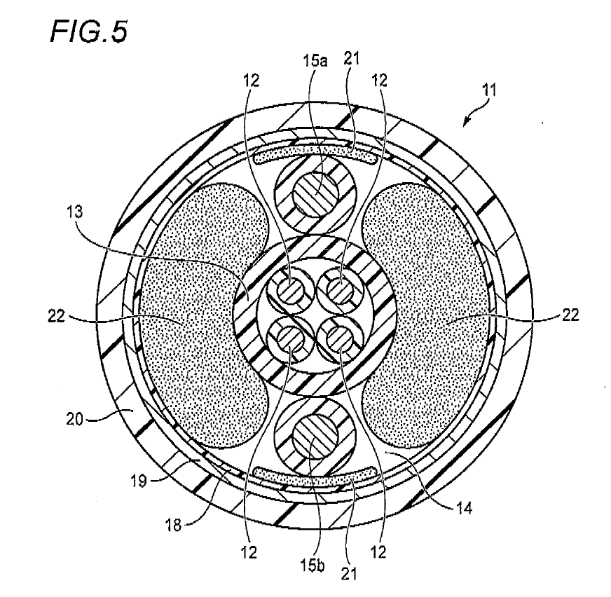

In addition, a comparative example was produced as follows. As illustrated in FIG. 5, four optical fiber cores 12 having an outside diameter of 0.25 mm was accommodated in a protective tube 13 having an inside diameter of 1.0 mm and an outside diameter of 2.0 mm. Two electric wires 15 (one electric wire 15a for positive electrodes and one electric wire 15b for negative electrodes) of AWG 24 according to the AWG (American Wire Gauge) standard were arranged on the outer periphery of the protective tube 13 in a layer-stranded state around the protective tube 13. The outside diameter of the electric wire 15 was 0.76 mm. In addition, filler 22 (nylon yarn) was disposed between the electric wire 15a for positive electrodes and the electric wire 15b for negative electrodes. The pitch of the layer strands of each of the electric wires 15 was 60 mm. Kevlar 21 was disposed outside the electric wires 15. In addition, each of the electric wires 15 was used as a power supply wire.

As a result of configuring the comparative example as described above, the optical fiber cores 12, the protective tube 13, the electric wires 15, and the Kevlar 21 described above were able to be accommodated in a jacket 20 (PVC tube) having an inside diameter of 3.8 mm and an outside diameter of 4.8 mm.

As in the above-described example, by dividing the electric wires 15 into a plurality of (six) electric wires and arranging the divided electric wires on the outer periphery of the protective tube 13 at equal intervals in the layer-stranded state, the outside diameter of the jacket 20, that is, the outside diameter of the photoelectric composite cable 11 was able to be reduced by about 0.6 mm, compared to the comparative example. In the case of the comparative example, the diameter of the electric wires 15 and the filler 22 (nylon yarn) layer-stranded around the protective tube 13 was greater than that in the example, and thus the inside diameter of the jacket 20 had to be increased. The outside diameter of the jacket 20 was increased by the extent, and thus the photoelectric composite cable 11 was also thickened. In addition, in the case of the comparative example, there were only two electric wires 15, and thus the lateral portion of the cable where the electric wires 15 were present were stretched and the photoelectric composite cable 11 had meandered. Meandering of the photoelectric composite cable 11 is a cause of an increase in transmission loss of the optical fiber cores 12 held therein. Contrary to this, in the case of the example, since the six electric wires 15 were arranged in the periphery of the protective tube 13 at equal intervals, meandering of the photoelectric composite cable 11 due to a stretch could be prevented, and thus an influence on transmission loss could be prevented.

While the present inventive concept has been shown and described with reference to certain exemplary embodiments thereof, it will be understood by those skilled in the art that various changes in form and details may be made therein without departing from the spirit and scope of the invention as defined by the appended claims.

1. A photoelectric composite cable comprising:
an optical fiber; and
a plurality of three or more power supply wires,
wherein, in a case where a cross-section of the photoelectric composite cable is viewed in a direction perpendicular to the cross-section, the plurality of power supply wires are each independently arranged on a circumference of a periphery of the optical fiber.

2. The photoelectric composite cable according to claim 1, further comprising:
a protective tube which accommodates the optical fiber therein,
wherein, in the case where the cross-section of the photoelectric composite cable is viewed in the direction perpendicular to the cross-section, the plurality of power supply wires are arranged to be unidirectionally stranded or stranded in two different directions on an outer periphery of the protective tube.

3. The photoelectric composite cable according to claim 1,
wherein, in the case where the cross-section of the photoelectric composite cable is viewed in the direction perpendicular to the cross-section, the plurality of power supply wires are arranged at equal intervals on the outer periphery of the protective tube.

4. The photoelectric composite cable according to claim 1, further comprising:
connectors having a positive electrode and a negative electrode,
wherein the plurality of power supply wires are connected to at least one of the positive electrode and the negative electrode.

5. The photoelectric composite cable according to claim 4,
wherein, among the plurality of power supply wires, the power supply wires connected to the positive electrode are arranged to be adjacent to one another, and the power supply wires connected to the negative electrode are arranged to be adjacent to one another.

6. The photoelectric composite cable according to claim 4,
wherein the connectors have any one of a light-receiving element which converts an optical signal into an electrical signal and a light-emitting element which converts an electrical signal into an optical signal.
